(19) United States
(12) Patent Application Publication
(10) Pub. No.: US 2005/0003043 A1
(43) Pub. Date: Jan. 6, 2005

(54) Composition and method for reducing caking and proteinaceous products

(76) Inventors: Vincent Sewalt, West Des Moines, IA (US); Sally Moore, Ankeny, IA (US)

Correspondence Address: DAVIS, BROWN, KOEHN, SHORS & ROBERTS, P.C.;THE FINANCIAL CENTER, 666 WALNUT STREET, SUITE 2500, DES MOINES, IA, 50309-3993, US

(21) Appl. No.: 10/613,714

(22) Filed: Jul. 3, 2003

(51) Int. Cl. A23L 1/10

(52) U.S. Cl. 426/18

(57) ABSTRACT

A method and composition for reducing caking of proteinaceous products such as dried distiller's grains, corn gluten feed, fish meal, feather meal, soybean meal and other oilseed meals, and the like, particularly during transport and storage. The composition may include a reducing agent either alone or in combination with a chaotroph. Optionally, the composition includes an enzyme which may be added to the composition or substituted for all or part of the reducing agent. The composition also optionally includes a material which assists in maintaining a reducing condition in the proteinaceous product, and optionally a material which assists in blocking of free sulfhydryl groups.

### BACKGROUND OF THE INVENTION

The invention relates generally to compositions which reduce caking in proteinaceous products and, more specifically, to compositions containing reducing agents and chaotrophs which reduce or prevent hardening or caking of proteinaceous products such as dried distillers grains, corn gluten feed, fish meal, feather meal, soybean meal and other oilseed meals, and the like, particularly during transport and storage.

Proteinaceous products such as dried distiller's grains, soybean meal, fish meal, and the like are widely used in the animal feed industry as protein supplements in feed rations. These products are known to harden or cake under certain conditions, requiring additional processing prior to use. Dried distiller's grains constitute a highly nutritious, high-value co-product derived from the dry grind ethanol process. Dried distiller's grains are often transported by rail from ethanol plants, primarily located in the Midwest near grain production areas, to feed lots and large dairies near the West Coast (e.g., Idaho, Calif.). Dried distiller's grains are usually loaded hot into rail cars. While in transit, the dried distiller's grains often harden to form a continuous cake that is difficult to remove from the rail car once it arrives at its destination. This occurs predominantly in the months of May to September when drying conditions are suboptimal. The removal of hard dried distiller's grains is costly and may cause significant damage to the rail car. The current method of preventing caking of dried distiller's grains is by extensive drying, a process which is inefficient and costly.

Dried distiller's grains are the subject of increasing interest as an animal feed product, particularly for ruminant animals. Additionally, with the promotion of ethanol as a renewable fuel, ethanol production is growing rapidly, resulting in an increase in the volume of dried distiller's grains being produced. There is, accordingly, a need to effectively and economically reduce or prevent caking of the dried distiller's grains during transport and storage.

### SUMMARY OF THE INVENTION

The invention consists of compositions including reducing agents and chaotrophs, used either alone or, preferably, in combination with each other, or in combination with other materials, which are added to a proteinaceous product to prevent hardening or caking of the product during transport and storage. The reducing agents include, but are not limited to, sodium bisulfite, disodium sulfite, sodium sulfide, dithiothreietol, beta-mercaptoethanol, and sulfur dioxide. The chaotrophs include, but are not limited to, ammonia, urea, and guanidine hydrochloride. In an alternative embodiment of the invention, enzymes are used in the compositions either in addition or in substitution for all or part of the reducing agents. Suitable enzymes include, but are not limited to, thioredoxin h (TRX h), thioredoxin reductase, protein disulfide reductase, keratinase, and papain.

The compositions may optionally include other materials or compounds which assist in maintaining reducing conditions, such as antioxidants, including but not limited to TBHQ, BHA, BHT, propyl gallate, carnosic acid, and plant extracts. Reducing conditions inside containers in which the proteinaceous products are stored or transported may also be enhanced by flushing with nitrogen, carbon dioxide or any other inert gas. The compositions may optionally include compounds which assist in blocking of free sulfhydryl groups including, but not limited to, oxidized glutathione, ascorbic acid, sodium sulfite, and N-ethylmaleimide. Many of these components are effective individually under appropriate conditions and if used in sufficient quantities. However, combinations of the components provide synergies that improve the effectiveness of the compositions over a broader range of conditions and decrease the amounts required and reduce the cost of effective treatment.

The compositions are formulated into a dry or liquid product and added to the proteinaceous product being treated by stirring or other method to assure distribution of the compositions throughout the volume of the product. In the example of dried distiller's grains, the composition is formulated into a liquid that is sprayed onto, or a dry product that is mixed into, the stream of the dried distiller's grains as they exit the production facility. The chemical compositions are applied to the proteinaceous products in the range of between about 0.01 weight percent to about 5 weight percent, and preferably between about 0.1 weight percent to about 2 weight percent.

An object of the invention is to provide compositions for the treatment of proteinaceous products which reduce or eliminate hardening or caking of the products.

Another object of the invention is to provide compositions which create and maintain a reducing environment in proteinaceous products to reduce or eliminate hardening or caking of the products.

A further object of the invention is to provide compositions for the treatment of proteinaceous products which reduces caking of the products during transport and storage so that the products are more easily and efficiently dispensed.

Yet another object of the invention is to provide compositions of chaotrophs together with chemical reducing agents and/or enzymes which reduce caking of dried distiller's grains during rail transport to make removal of the dried distiller's grains from the rail cars faster, easier, and with less damage to the rail cars.

These and other objects of the invention will be understood by those skilled in the art upon a review of this specification, the associated drawings, and the appended claims.

### BRIEF DESCRIPTION OF THE DRAWINGS

FIG. 1 is a graphical representation of data representing the prevention of caking in dried distiller's grains treated with a formulation of the present invention.

### DETAILED DESCRIPTION OF A PREFERRED EMBODIMENT

During the dry grind ethanol process, the starch in corn is liquefied and/or fermented to ethanol, leaving the residue consisting mainly of endosperm zein protein, germ protein, germ oil and fiber. The endosperm proteins in corn are predominantly alcohol-soluble zeins, of which particularly the γ-zeins are highly cross-linked via disulfide bonds. During the ethanol fermentation process, some of these proteins denature and solubilize, but a large portion of the zein network remains intact. It is believed that during heat drying further denaturation of the proteins occurs, involving reduction of protein disulfide bonds and breakage of hydrogen bonds, following which new disulfide and hydrogen bonds may be established during drying and during cool-down of the dried distiller's grains. In essence, it is believed that a redistribution of protein disulfide bonds and hydrogen bonding occurs which contributes to the observation of caking and hardening of the dried distiller's grains in rail cars during transportation.

During the wet corn milling process, corn is steeped in a solution containing a reducing agent such a sulfur dioxide and the germ is removed from the corn kernel. The steeping process softens the corn endosperm, allowing for separation of starch granules from the endosperm protein matrix, leaving a residue consisting largely of fiber and endosperm protein termed wet corn gluten feed. It is believed that during subsequent drying of the resulting wet corn gluten feed, the initially reduced protein disulfide bonds will redistribute similar to the process described above for distillers' grains. The dried corn gluten feed is often pelleted and cooled, but limited cooler capacity may necessitate loading of warm and soft corn gluten feed pellets in rail cars or trucks, resulting in significant caking during transport and storage as well.

Although additional chemical reactions, for example, the formation of Maillard products from sugars and amino groups and cell-wall crosslinking via the generation of quinone groups from phenolics, cannot be discounted as playing a role in dried distiller's grains and corn gluten feed caking, their contribution does not appear to be as large. The indigestible endosperm remnant consists mostly of the zein protein network, which is, therefore, the primary entity believed to cross-link. Furthermore, the color of dried distiller's grains and well-processed corn gluten feed remains golden yellow, not brown, the typical color of Maillard products. In addition, mold growth appears not to be the problem in caking of dried distiller's grains, as the phenomenon does occur in visually mold-free dried distiller's grains.

Minimizing the degree of cross-linking of the endosperm zeins and gluten proteins can be accomplished by: (a) Interrupting hydrogen bonding and the water/protein network with so-called chaotrophs, providing competition for H-bonding and increasing solution entropy; chaotrophs would include ammonia, urea, and guanidine hydrochloride; (b) reducing protein disulfide bonds, either chemically, with reducing agents, for example sodium metabisulfite, sodium sulfite, sodium sulfide, dithiothreitol, β-mercaptoethanol, and sulfur dioxide or enzymatically, with protein disulfide reductase activities, such as protein disulfide isomerase, thioredoxin (TRX), NADPH-dependent thioredoxin reductase, keratinase, and papain; and (c) blocking free sulfhydryl groups from forming disulfide bonds by derivitization, using for example glutathione, ascorbid acid, N-ethylmaleimide.

Accordingly, formulations or compositions of the present invention may include reducing agents and/or chaotrophs which are added to a proteinaceous product to prevent hardening or caking of the product during transport and storage. The reducing agents include, but are not limited to, sodium bisulfite, disodium sulfite, sodium sulfide, dithiothreietol, beta-mercaptoethanol, and sulfur dioxide. The chaotrophs include, but are not limited to, ammonia, urea, and guanidine hydrochloride.

In an alternative embodiment of the invention, enzymes are used in the compositions either in addition to or in substitution for all or part of the reducing agents. Suitable enzymes include, but are not limited to, thioredoxin h (TRX h), thioredoxin reductase, protein disulfide reductase, keratinase, and papain.

The compositions may optionally include compounds which assist in maintaining reducing condition, such as antioxidants, including but not limited to TBHQ, BHA, BHT, propyl gallate, carnosic acid, and plant extracts. Reducing conditions inside containers in which the proteinaceous products are stored or transported may also be enhanced by flushing with nitrogen, carbon dioxide or any other inert gas. The compositions may optionally include compounds which assist in blocking of free sulfhydryl groups including, but not limited to, oxidized glutathione, ascorbic acid, sodium sulfite, and N-ethylmaleimide.

The reducing agent is added to the proteinaceous products in an amount between about 100 ppm and about 10,000 ppm weight percent and are selected from the group comprising sodium bisulfite, disodium sulfite, sodium sulfide, dithiothreietol, and beta-mercaptoethanol to the proteinaceous product; the chaotroph is added in an amount between about 1000 ppm and about 40,000 ppm and selected from the group comprising ammonia, urea, and guanidine hydrochloride; the enzyme is added in an amount between about 0.01 ppm about 1000 ppm and selected from the group comprising thioredoxin h (TRX h), thioredoxin reductase, protein disulfide reductase, keratinase, and papain; a material which assists in maintaining a reducing condition is added in an amount between about 100 ppm and about 10,000 ppm and selected from the group comprising TBHQ, BHA, BHT, propyl gallate, carnosic acid, and plant extracts; and a material which assists in blocking of free sulfhydryl groups added in an amount between about 100 ppm and about 10,000 pmm and selected from the group comprising oxidized glutathione, ascorbic acid, sodium sulfite, and N-ethylmaleimide

The compositions are formulated into a liquid or dry product and added to the proteinaceous product being treated by stirring or other method to assure distribution of the compositions throughout the volume of the product. In the example of dried distiller's grains, the composition is formulated into a liquid that is sprayed onto the stream of the dried distiller's grains as they exit the production facility. Alternatively, a dry formulation can be prepared by anyone skilled in the art that includes one or several of the active ingredients plus a moisture scavenger/carrier to aid in product dispersion. The carrier would be selected from the group comprising corn cob, rice hulls, calcium carbonate, calcium sulfate, vermiculite, and similar carriers. The compositions are applied to the proteinaceous products in the range of between about 500 ppm to about 50,000 ppm, and preferably between about 1000 ppm to about 10,000 ppm.

Materials and Methods

Dried distiller's grains of approximately 10% moisture content were received from an ethanol plant in Glenville, Minn., which uses corn as a starting material. Moisture content was confirmed to be 14.2% by overnight drying in a vacuum oven at 95° C. All dried distiller's grains caking simulation and intervention tests were performed in duplicate (unless noted otherwise), utilizing duplicate batches of 100 g dried distiller's grains in glass jars. Various preliminary trials were performed to establish the conditions mimicking the caking phenomenon of dried distiller's grains in rail cars during transport. The following conditions were established and used in subsequent experiments:

Treatment procedure. One hundred grams of dried distiller's grains are heated in an open container (glass 250 ml wide mouth jar) at 105° C. under pressure and humidity (in an autoclave) for 15 minutes. Under these conditions, minimal browning occurs as opposed to more harsh conditions of heating at 121° C. for 30 minutes. After allowing the jars to cool to the touch (approx 60° C.), the contents are loosened from the jar, and compositions of the present invention are applied. The contents are mixed with glass stirring rod, and repacked into the glass jar, after which the jar is securely closed. Packing is accomplished by adding three separate times approximately one-third of the volume of the dried distiller's grains into the jar and tapping 10 times with the rounded end of a pestle after each addition. Jars are placed into a 37° C. environment overnight or longer (up to 1 week to simulate extended hold in a railcar).

Observations and measurements. The jars are gently removed from the incubator and turned upside down. They are tapped on the bench top 5 times to determine the relative amount of release of the dried distiller's grains. This is followed by a ”strike count test”, in which the force required to undo the dried distiller's grains from rail cars is mimicked by striking the jar against the side of a plastic waste disposal can. This procedure generates a reproducible number that simulates the force required to remove the dried distiller's grains. Each jar is struck up to 10 times, and the length of the remaining plug recorded. If any dried distiller's grains are left, the jar is struck up to an additional 10 times, and the length of the remaining plug recorded and photographed. If all dried distiller's grains are removed within 10 or 20 strikes, the number of strikes is recorded.

Experiments. The series of individual experiments included evaluation of moisture content, addition of various reducing agents, antioxidants, ammonia, urea, ascorbic acid, and the application of inert gas to remove oxygen. The treatments are discussed in more detail for each experiment individually in the results section.

Results

Experiment 1. The following duplicate treatments were applied prior to repacking:
Control—added 4% (wt/wt) sterile water;
Reducing Agent (RA)—4% (wt/wt) of 100 mM sodium sulfite (˜500 ppm on the dried distiller's grains);
Antioxidant (AO)—500 ppm (wt/wt) TBHQ (0.05 g TBHQ to 100 g dried distiller's grains);
Reducing Agent/Antioxidant (RA/AO)—4% (wt/wt) 100 mM sodium sulfite and 500 ppm TBHQ.

After treatment, application and repacking, the jars were held at 37° C. for 72 hours. Observations of the initial release after 5 taps on the bench-top from the dried distiller's grains plug developed during the exposure to heat and subsequent cool down showed improved release of the dried distiller's grains treated with antioxidant and with a combination of a reducing agent and antioxidant. Further loosening of the plug by repeated force (up to 20 times) applied to the side of the jar resulted in more differentiation between control and treatments (Table 1). None of the treatments resulted in complete removal of the DDG plug.

TABLE 1
Height (cm) of column of dried distiller's grains remaining
in jars as impacted by 500 ppm of reducing agent
and antioxidant addition (2 replicates each)

| | Control | Na₂SO₃ | TBHQ | Na₂SO₃ + TBHQ |
|---|---|---|---|---|
| Replicate 1 | 6.2 | 6.2 | 5.6 | 2.5 |
| Replicate 2 | 6.2 | 5.6 | 6.2 | 1.0 |
| Mean ± SE | 6.2 ± 0.0 | 5.9 ± 0.3 | 5.9 ± 0.3 | 1.75 ± 0.75 |

As the data resulting from the strike test appeared to be most informative in differentiating various treatments from one another and from control, the results from the strike test are used.

Experiment 2. To assess the impact of moisture content, a comparison was made between two types of controls, one of which had 4% distilled water added prior to repacking, the results of which is shown in Table 2. Clearly, added moisture facilitates the caking of dried distiller's grains. This also indicates that a solution to the dried distiller's grains caking may allow for higher moisture content of the dried distiller's grains to be shipped, representing a reduction in drying costs and an increase in dried distiller's grains weight to be shipped and sold.

TABLE 2
Mean column height of dried distiller's grains
plug remaining in jars after 10 or 20 strikes
as impacted by added moisture.

| | Plug height | Plug height | # of strikes to |
|---|---|---|---|
| | (cm) after | (cm) after | release all |
| Treatment | 10 strikes | 20 strikes | DDG |
| Control w/4% water | 6.35 ± 0.0 | 5.1 ± 0.0 | n.a. |
| Control (no additional | 0.0 | 0.0 | 10 ± 0.0 |
| moisture) | | | |

Experiment 3. To confirm the efficacy of reducing agents and antioxidants, to evaluate the impact of removing oxygen, and to evaluate intervention into hydrogen bonding, the following duplicate treatments were applied prior to repacking:
Control—added 4% (wt/wt) sterile water;
Reducing agent—4% (wt/wt) of 1 M sodium sulfite (Na₂SO₃) solution;
Antioxidant—1000 ppm (wt/wt) TBHQ;
Reducing agent and antioxidant—4% (wt/wt) 1 M Na₂SO₃ and 1000 ppm TBHQ;
Ammonium hydroxide—4% by weight;
Argon flush—packed dried distiller's grains flushed for one minute with argon gas and sealed immediately; and
Reducing agent/argon flush—dried distiller's grains treated with 4% (wt/wt) of 1M Na₂SO₃, packed into jar, flushed with argon gas for one minute after packing and sealed immediately.

After the initial heating step, application of the respective treatments, and repacking, the jars were held at 37° C. for overnight followed by visual assessment and data collection. After the initial five taps on the bench top, the antioxidants and reducing agent/antioxidant treatments as well as the ammonia treatment resulted in substantial loss from the dried distiller's grains plug in the jar. Next, the “strike count test” was conducted and the remaining dried distiller's grains plug height measured. The test was performed in 2 blocks, with one jar representing each treatment randomly selected. The strike count tests generated the data presented in Table 3 and confirm the positive impact of the reducing agent and the antioxidant, but indicate a possible interaction between this antioxidant and the reducing agent. The results obtained with argon point to the positive impact of removing oxygen by flushing with an inert gas. However, the reduced oxygen potential obtained with the argon flush appeared to decrease the efficacy obtained with sodium sulfite, leading to a potential redefinition of the function of a reducing agent in this system, such as generation of sulfhydryl groups by the oxidized form of sodium sulfite. Finally, the hydrogen bonding intervention strategy seems validated with a very positive response in the strike test to ammonia.

TABLE 3
Mean column height of dried distiller's grains plug remaining
in jars after 10 or 20 strikes as impacted by a reducing agent,
an antioxidant, inert gas, and ammonium hydroxide

| | Plug height | Plug height | # of strikes to |
|---|---|---|---|
| | (cm) after | (cm) after | release all |
| Treatment | 10 strikes | 20 strikes | DDG |
| Control | 5.3 ± 0.3 | 4.4 ± 0.0 | n.a. |
| Na₂SO₃ | 4.4 ± 0.0 | 1.9 ± 1.9 | 16 (1 of 2 |
| | | | reps) |
| TBHQ | 0.0 | 0.0 | 6.5 ± 0.5 |
| Na₂SO₃/TBHQ | 2.5 ± 2.5 | 0.0 | 13.5 ± 3.5 |
| Na₂SO₃/argon | 5.0 ± 0.0 | 4.4 ± 0.7 | n.a. |
| Argon flush | 4.7 ± 0.9 | 0.0 | 18.5 ± 1.5 |
| NH₄OH | 0.0 | 0.0 | 9.0 ± 1.0 |

Experiment 4. A additional experiment was performed to confirm and expand upon the results of Experiment 3. Treatments in Experiment 4 included:
Control—added 4% (wt/wt) sterile water
Reducing Agent 1—4% (wt/wt) of 1 M sodium metabisulfite (Na₂S₂O₅)
Reducing Agent 2—4% (wt/wt) of 1 M sodium sulfite (Na₂SO₃) solution
Antioxidant—1000 ppm TBHQ
Reducing Agent/Antioxidant—4% (wt/wt) 1 M solution of either reducing agent 1 or 2 and 1000 ppm TBHQ
Reducing agent/argon flush—4% (wt/wt) of 1 M solution of either reducing agent 1 or 2, flushed with argon gas for one minute after packing and sealed immediately after flush.

All jars were processed as described previously. Results of the “strike count test” in Experiment 4 are shown in Table 4, and demonstrate that results obtained with one reducing agent (sodium sulfite) can be replicated with another (sodium metabisulfite), confirms TBHQ as effective, points at synergy provided by the addition of TBHQ or inert gas to sodium metabisulfite, and confirms the apparent negative impact of adding an antioxidant or providing low oxygen potential to sodium sulfite. It appears that sodium metabisufite may act exclusively as a weak reducing agent, with its action enhanced by antioxidant/low oxygen, whereas oxidized sodium sulfite may also further react with proteins to aid in reducing cross-links.

TABLE 4
Mean column height of dried distiller's grains plug remaining
in jars after 10 or 20 strikes as impacted by a two different
reducing agents, an antioxidant, and inert gas

| | Plug height | Plug height | # of strikes to |
|---|---|---|---|
| | (cm) after | (cm) after | release all |
| Treatment | 10 strikes | 20 strikes | DDG |
| Control | 5.9 ± 0.3 | 5.3 ± 0.3 | n.a. |
| Na₂S₂O₅ | 2.5 ± 0.6 | 1.25 ± 1.25 | 18 (1 of 2 |
| | | | reps) |
| Na₂SO₃ | 0.0 | n.a. | 7.5 ± 0.5 |
| TBHQ | 0.0 | n.a. | 3.5 ± 0.5 |
| Na₂S₂O₅/TBHQ | 4.4 ± 1.85 | 2.8 ± 2.8 | 13 (1 of 2 |
| | | | reps) |
| Na₂SO₃/TBHQ | 2.5 ± 2.5 | 1.6 ± 1.6 | 10 (1 of 2 |
| | | | reps) |
| Na₂S₂O₅/argon | 0.0 | n.a. | 8.5 ± 1.5 |
| Na₂SO₃/argon | 4.4 ± 1.25 | 2.5 ± 2.5 | 14 (1 of 2 |
| | | | reps) |

Experiment 5. As 4% (wt/wt) ammonium hydroxide was highly effective in Experiment 3, lower treatment levels would need to be explored to establish dose response. However, because application of ammonia alone appeared impractical (due to the sharp odor and high alkalinity) it was decided to explore the use of urea. Urea is a well-known chaotrophic agent used at high concentrations (3 to 8 M) in the laboratory to denature and dissolve proteins prior to display in gels. In addition we pursued an extension of the observations made with less expensive antioxidants as alternatives to TBHQ, resulting in the following the experimental design:
Control—added 4% (vol/wt) sterile water
Urea/AO—1000 ppm urea/1000 ppm TBHQ, in 4% (vol/wt) sterile water
Urea—1000 ppm, in 4% sterile water
Urea—5000 ppm, in 4% sterile water (no replication)
BHT—1000 ppm in 4% sterile water
BHA—1000 ppm in 4% sterile water
Urea/Reducing Agent 1—1000 ppm urea in 4% 1M sodium metabisulfite solution
Urea/Reducing Agent 2—1000 ppm urea in 4% 1 M sodium sulfite solution.

All jars were processed as described previously. Replicate sample sets were formed by random selection of one jar from each treatment group. The experimental results indicate some efficacy for urea alone when applied at 5000 ppm (i.e., 0.5%, wt/wt). This compares favorably with the previous results obtained with 4% ammonia. When applied alone at 1000 ppm, urea was ineffective. However, in combination with the reducing agents all dried distiller's grains were removed within 7 to 14.5 strikes. The two alternative antioxidants did improve the release of dried distiller's grains, with the more effective one, BHT, being a good alternative to TBHQ.

TABLE 5
Mean column height of dried distiller's grains plug remaining
in jars after 10 or 20 strikes as impacted by tow levels of
urea, urea added to previously tested reducing agents and
to an antioxidant (TBHQ), and two alternative antioxidants

| | Plug height | Plug height | # of strikes to |
|---|---|---|---|
| | (cm) after | (cm) after | release all |
| Treatment | 10 strikes | 20 strikes | DDG |
| Control | 5.6 ± 0.0 | 5.6 ± 0.0 | n.a. |
| Urea/TBHQ | 2.8 ± 2.8 | 2.0 ± 2.0 | 9 (1 of 2 reps) |
| Urea/Na₂S₂O₅ | 3.75 ± 1.25 | 0.0 | 14.5 ± 0.5 |
| Urea/Na₂SO₃ | 0.0 | n.a. | 7.0 ± 0.0 |
| Urea, 1000 ppm | 5.0 ± 0.6 | 4.05 ± 1.55 | n.a. |
| Urea, 5000 ppm^{a} | 0.0 | n.a. | 10^{a} |
| BHT | 1.55 ± 1.55 | 0.0 | 11 ± 2.0 |
| BHA | 3.45 ± 0.35 | 1.25 ± 1.25 | 20 (1 of 2 |
| | | | reps) |

^{a}One observation only.

Experiment 6. To assess whether the effect of reducing agents can be achieved with enzymes, an experiment was conducted with the following treatments (per 10 g of dried distiller's grains):
Control—added 1 ml sterile water, i.e., 10% (wt/wt);
Thioredoxin h (TRX h) enzyme treatment, 0.3 μg E. coli TRX h (Sigma) in 1 ml of 30 mM Tris-HCL buffer, pH 7.5, containing 1 mM DTT (dithiothreitol). A low concentration of DTT (1 mM) is added to maintain TRX h in reduced state, this equates to only 15.4 parts of DTT per million parts of dried distiller's grains, unlikely to have a direct effect; and
1 ml 100 mM DTT/30 mM Tris-HCL, pH 7.5. This equates to 1540 ppm DTT, similar to the 1000 ppm application rate of other antioxidants in previous experiments.

In addition, ascorbic acid, 1000 ppm in 1 ml sterile water, was evaluated as potential antioxidant/reducing agent.

The added moisture in this experiment was 10% rather than the 4% used in previous experiments to facilitate the enzyme application. All jars were processed as previously described. The results indicate an improvement in dried distiller's grains release (i.e, reduced caking) with the use of thioredoxin enzyme, with high concentrations of the reducing agent DTT, and with bifunctional ascorbic acid.

TABLE 6
Mean column height of dried distiller's grains plug remaining
in jars after 10 or 20 strikes as impacted by thioredoxin
h enzyme, reducing agent (DTT) and ascorbic acid.

| | Plug height | Plug height | |
|---|---|---|---|
| | (cm) after 10 | (cm) after 20 | # of strikes to |
| Treatment | strikes | strikes | release all DDG |
| Control (water) | 2.2 ± 2.2 | 1.55 ± 1.55 | 10 (1 rep) |
| TRX/1 mM | 0.5 ± 0.5 | 0.38 ± 0.38 | 9 (1 rep) |
| DTT/Tris | | | |
| 100 mM | 0.0 | n.a. | 8 ± 1 |
| DTT/Tris | | | |
| Ascorbic acid/ | 0.0 | n.a. | 5.5 ± 1.5 |
| water | | | |

As the preliminary results with ascorbate were promising, additional experiments were pursued to determine the effectiveness of ascorbic acid to reduce the caking phenomenon.

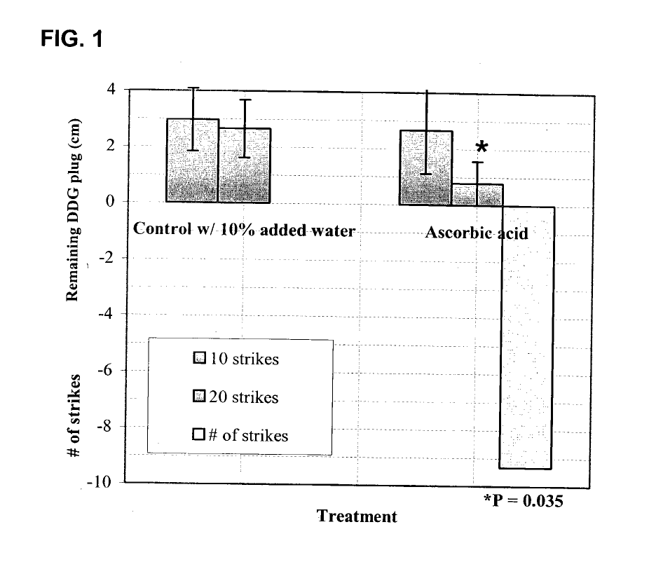

Experiment 7. Additional sets of comparisons introduced 10% moisture to the dried distiller's grains to examine a possible “worse case” scenario. Total overall theoretical moisture level was 24.2%. The effects of 1000 ppm ascorbic acid in dried distiller's grains with 10% added moisture were evaluated as compared to untreated dried distiller's grains (10% water only). Duplicate samples were prepared, the experiment performed twice (n=4), and the data analyzed by one-side t-test. The error bars indicate ±1 SE. The graph shows that the impact of ascorbic acid on dried distiller's grains removal was significant (P=0.035) after 20 strikes. For the two replicates for which all dried distiller's grains were removed within 20 strikes, the mean force required was only 9.3 strikes. The results displayed in FIG. 1 clearly indicate the statistically significant impact of non-reduced ascorbic acid on dried distiller's grains caking.

Experiment 8. To assess whether the effect of ascorbic acid is counteracted by antioxidants, the following treatments were applied in duplicate prior to repacking:
Control (untreated);
Ascorbic acid (as a reducing agent)—1000 ppm (wt/wt);
Ascorbic acid/BHT—1000 ppm each (wt/wt); and
Ascorbic acid/TBHQ—1000 ppm each (wt/wt).

The results shown in Table 7 confirm the efficacy of ascorbic acid, but point again at the negative impact of adding a reducing agent to ascorbic acid. Apparently, ascorbic acid is more effective in reducing the protein cross-linking and dried distiller's grains caking when applied in the absence of reducing agents. Its presumed function, empirically, is thus to block the oxidation of free sulfhydryl groups into disulfide bonds.

TABLE 7
Mean column height of dried distiller's grains plug remaining
in jars after 10 or 20 strikes as impacted by ascorbic acid
and with or without two different reducing agents

| | Plug height | Plug height | |
|---|---|---|---|
| | (cm) after 10 | (cm) after 20 | # of strikes to |
| Treatment | strikes | strikes | release all DDG |
| Control | 4.69 ± 0.94 | 3.75 ± 1.25 | n.a. |
| Ascorbic acid | 0.0 | 0.0 | 5 ± 0 |
| Ascorbic/BHT | 4.38 ± 1.25 | 2.19 ± 2.19 | 13 (1 rep) |
| Ascorbic/TBHQ | 2.5 ± 2.5 | 2.5 ± 2.5 | 9 (1 rep) |

Without being restricted to a particular theory of operation, it is believed that the results from these experiments support the theory that disulfide and hydrogen bonds play a role in the caking of proteinaceous products such as dried distiller's grains and corn gluten feed, in that the application of reducing agents, antioxidants, and chaotrophs aids in reducing the incidence or delaying the onset of the caking problem, or both. The results also support the need for protection of some reducing agents from oxidation as evidenced by the synergistic effect of combining sodium metabisulfite with antioxidants or reduced oxygen potential. On the other hand, other reducing agents (sodium sulfite, ascorbic acid) may be bifunctional in that the oxidized forms may interact even more strongly with proteins that the reduced forms. Alternative forms of the compositions are believed to reduce disulfide bonds, preventing the sulfhydryl groups that are in a reduced state to re-oxidize into disulfide bonds, and breaking the hydrogen bonding, thereby minimizing the degree of cross-linking of zeins and sulfur-rich gluten proteins in dried distiller's grains and other proteinaceous products. The experiments reported in this paper exemplify that this can be accomplished with (a) chemical reducing agents, including but not limited to sodium bisulfite, disodium sulfite, sodium sulfide, dithiothreietol, beta-mercaptoethanol, sulfur dioxide, (b) enzymes or enzyme systems that reduce protein disulfide bonds, including but not limited to thioredoxin h (TRX h), thioredoxin reductase, protein disulfide reductase , keratinase, or papain, and/or (c) chaotrophic agents, including but not limited to ammonia, urea, guanidine hydrochloride.

The experiments also show that reduction in caking of proteinaceous products can be achieved or enhanced by the maintenance of generally reducing conditions (i.e., reduced oxygen pressure), to maintain the sulfhydryl groups in a reduced state, avoiding exhaustion of reducing agents and/or maintain protein disulfide reductase activity; reducing conditions are likely to occur inside large stacks of grain or animal by-product, in silos, and could be enhanced by flushing with nitrogen, carbon dioxide or any other inert gas, or by the inclusion of general antioxidants, including but not limited to TBHQ, BHA, BHT, and propyl gallate, and by blocking of free sulfhydryl groups by reaction with compounds, including but not limited to oxidized glutathione, ascorbic acid, possibly sodium sulfite, and N-ethylmaleimide.

Although the invention has been described with respect to a preferred embodiment thereof, it is to be also understood that it is not to be so limited since changes and modifications can be made therein which are within the full intended scope of this invention as defined by the appended claims.

1. A method for treating a proteinaceous product to decrease the degree of caking during storage or transport, comprising the steps of:
(a) adding a reducing agent to the proteinaceous product in an amount between 0 ppm and up to about 10,000 ppm; and
(b) adding a chaotroph to the proteinaceous product in an amount between 0 ppm and up to about 40,000 ppm.

2. A method as defined in claim 1, wherein the reducing agent is selected from the group comprising sodium bisulfite, disodium sulfite, sodium sulfide, dithiothreietol, beta-mercaptoethanol, and sulfur dioxide.

3. A method as defined in claim 1, wherein the chaotroph is selected from the group comprising ammonia, urea, and guanidine hydrochloride.

4. A method as defined in claim 1, further comprising the step of adding an enzyme to the proteinaceous product in an amount up to about 1000 ppm.

5. A method as defined in claim 5, wherein the enzyme replaces all or a part of the reducing agent.

6. A method as defined in claim 4, wherein the enzyme is selected from the group comprising thioredoxin h (TRX h), thioredoxin reductase, protein disulfide reductase, keratinase, and papain.

7. A method as defined in claim 1, further comprising the step of adding a material which assists in maintaining a reducing condition in the proteinaceous product in an amount up to about 10,000 ppm.

8. A method as defined in claim 7, wherein the material is selected from the group comprising TBHQ, BHA, BHT, propyl gallate, carnosic acid, and plant extracts.

9. A method as defined in claim 7, wherein the proteinaceous product is contained in a substantially airtight container and wherein the step of adding a material which assists in maintaining a reducing condition in the proteinaceous product comprises flushing the container with nitrogen, carbon dioxide or any other inert gas.

10. A method as defined in claim 1, further comprising the step of adding a material which assists in blocking of free sulfhydryl groups in an amount up to about 10,000 ppm.

11. A method as defined in claim 10, wherein the material which assists in blocking of free sulfhydryl groups is selected from the group comprising oxidized glutathione, ascorbic acid, sodium sulfite, and N-ethylmaleimide.

12. A composition for treating a proteinaceous product to decrease the degree of caking during storage or transport, comprising:
(a) a reducing agent in an amount between 0 ppm and up to about 10,000 ppm of the proteinaceous product; and
(b) a chaotroph in an amount between 0 ppm and up to about 40,000 ppm of the proteinaceous product.

13. A composition as defined in claim 12, wherein the reducing agent is selected from the group comprising sodium bisulfite, disodium sulfite, sodium sulfide, dithiothreietol, beta-mercaptoethanol, and sulfur dioxide.

14. A composition as defined in claim 12, wherein the chaotroph is selected from the group comprising ammonia, urea, and guanidine hydrochloride.

15. A composition as defined in claim 13, wherein the chaotroph is selected from the group comprising ammonia, urea, and guanidine hydrochloride.

16. A composition as defined in claim 12, further comprising an enzyme in an amount up to about 1000 ppm of the proteinaceous product.

17. A composition as defined in claim 16, wherein the enzyme replaces all or a part of the reducing agent.

18. A composition as defined in claim 16, wherein the enzyme is selected from the group comprising thioredoxin h (TRX h), thioredoxin reductase, protein disulfide reductase, keratinase, and papain.

19. A composition as defined in claim 12, further comprising a material which assists in maintaining a reducing condition in the proteinaceous product in an amount up to about 10,000 ppm of the proteinaceous product.

20. A method as defined in claim 19, wherein the material is selected from the group comprising TBHQ, BHA, BHT, propyl gallate, carnosic acid, and plant extracts.

21. A composition as defined in claim 19, wherein the proteinaceous product is contained in a substantially airtight container and the container is flushed with nitrogen, carbon dioxide or any other inert gas.

22. A composition as defined in claim 12, further comprising a material which assists in blocking of free sulfhydryl groups in an amount up to about 10,000 ppm of the proteinaceous product.

23. A method as defined in claim 22, wherein the material which assists in blocking of free sulfhydryl groups is selected from the group comprising oxidized glutathione, ascorbic acid, sodium sulfite, and N-ethylmaleimide.

24. A composition as defined in claim 12, wherein the reducing agent is included at between about 100 ppm and about 5000 ppm of the proteinaceous product; and wherein the chaotroph is included at between about 100 ppm and about 10,000 ppm of the proteinaceous product.

25. A composition as defined in claim 16, wherein the enzyme is included at between about 10 ppm and about 500 ppm of the proteinaceous product.

26. A composition as defined in claim 19, wherein the material which assists in maintaining a reducing condition in the proteinaceous product is included at between about 100 ppm and about 5,000 ppm of the proteinaceous product.

27. A composition as defined in claim 19, wherein the material which assists in blocking of free sulfhydryl groups in the proteinaceous product is included at between about 100 ppm and about 5,000 ppm of the proteinaceous product.

28. A method for treating dried distiller's grains to decrease the degree of caking during storage or transport, comprising the steps of:
(a) adding to the dried distiller's grains between 0 ppm and about 5,000 ppm of a reducing agent selected from the group consisting of sodium bisulfite, disodium sulfite, sodium sulfide, dithiothreietol, and beta-mercaptoethanol to the proteinaceous product;
(b) adding to the dried distiller's grains between 0 ppm and about 10,000 ppm of a chaotroph selected from the group consisting of ammonia, urea, and guanidine hydrochloride;
(c) adding to the dried distiller's grains between about 0 ppm and about 500 ppm of an enzyme selected from the group consisting of thioredoxin h (TRX h), thioredoxin reductase, protein disulfide reductase, keratinase, and papain;
(d) adding to the dried distiller's grains between about 0 ppm and about 5,000 ppm of a material which assists in maintaining a reducing condition in the proteinaceous product selected from the group consisting of TBHQ, BHA, BHT, propyl gallate, carnosic acid, plant extracts, or any inert gas that will exclude oxygen, preferably nitrogen or carbon dioxide; and
(e) adding to the dried distiller's grains between about 0 ppm and about 5,000 ppm of a material which assists in blocking of free sulfhydryl groups selected from the group consisting of oxidized glutathione, ascorbic acid, sodium sulfite, and N-ethylmaleimide.
